(19) United States
(12) Patent Application Publication
(10) Pub. No.: US 2021/0101814 A1
(43) Pub. Date: Apr. 8, 2021

(54) High Recovery Desalination and Mineral Production System and Method

(71) Applicant: Saline Water Conversion Corporation, Al-Jubail (SA)

(72) Inventors: Mohammed A. NAMAZI, Al-Jubail (SA); Amr M. MAHMOUD, Al-Jubail (SA); Christopher Michael FELLOWS, Al-Jubail (SA)

(21) Appl. No.: 16/595,641

(22) Filed: Oct. 8, 2019

(51) Int. Cl. C02F 9/00; B01D 9/00; B01D 15/10; B01D 61/02; B01D 61/08; B01D 61/46; B01D 61/58; C01F 11/00

(52) U.S. Cl. CPC C02F 9/00; B01D 9/0031; B01D 15/10; B01D 61/025; C02F 1/441; B01D 61/46; B01D 61/58; C01F 11/005; B01D 61/08

(57) ABSTRACT

A system and method for increasing the water production efficiency of a desalination plant and producing concentrated calcium and magnesium is provided. A saline source water is preferably subjected to a first treatment such a passage through a first desalination unit, followed by dual treatment of the first treatment reject stream using physicochemical adsorption and electrodialysis to remove scale-forming calcium and magnesium. The reject stream from the dual treatment may then be received by a second desalination unit. Due to the removal of the majority of the saline source water's scale-forming minerals, the second desalination unit may be operated at higher operating limits than in conventional desalination units without significant concern for fouling due to scaling. The approach of the present system and method efficiently increases the fresh water production ratio from the source saline water while generating commercially attractive concentrated calcium and magnesium products.

The present invention relates to design and operation of desalination facilities, and in particular to a system and method for improving water recovery and producing mineral byproducts.

### BACKGROUND AND SUMMARY OF THE INVENTION

In the desalination industry, freshwater is produced is various processes which convert seawater, brackish water, etc., into fresh water. For convenience of reference, at most locations herein reference is made to “seawater,” “saline water” or “feedwater” as the source water. These references are not intended to be limiting, as the source water may be any saline water recognized by those of ordinary skill in the art as possible feed water to a desalination facility.

In desalination a driving force is applied to remove the salts from the seawater by means of thermal energy such as MSF (Multi Stage Flash) and MED (Multiple Effect Distillation) or pressure energy such as reverse osmosis (RO), forward osmosis and membrane distillation, or a hybrid system combined between thermal and membrane systems.

Examples of thermal process-based systems include vertical tube evaporators, frequently operated with a mechanical vapor compressor (MVC) or a thermo-vapor compressor (TVC). For example, a two-stage MVC brine concentrator may require 24 kiloWatt-hours per cubic meter (kWh/m³) of product water in order to concentrate a feed water having total dissolved solids (TDS) of 70,000 parts per million (ppm) feed to 250,000 ppm. However, these traditional methods have high-energy consumption.

Typical desalination plants also have concerns with the management of the concentrated brine discharge remaining after separation of potable water (e.g. water with a total dissolved solids (TDS) level of approximately 300 parts per million (ppm) or less). Direct discharge of the brine in its concentrated form may adversely impact the marine environment. Alternative means for disposal of the concentrated brine are costly, due to the relatively large volume of this byproduct and the need to dispose of it in an environmentally responsible manner. The problems with concentrated brine may be at least partially addressed by extraction of minerals of commercial interest such as calcium and magnesium as byproducts which may be used in further applications and/or in to a zero liquid discharge system (membrane or thermal) to minimize environmental impact.

A primary obstacle to increased production of fresh water is the presence of the divalent ions calcium and magnesium which have a high scaling potential, as the amount of freshwater that can be produced from seawater is limited by the amount of inorganic scale produced, which in turn limits the top brine temperature (TBT) in thermal desalination (currently 112° C. for MSF systems and 65° C. for MED systems). The inorganic scale deposition also limits the concentration factor achievable in membrane production methods, which have are highly dependence on water quality. Many investigations have been carried out to increase the TBT of thermal desalination units and recovery of membrane processes to enhance the production and economics of production, but the risk of scaling has thwarted these efforts. Thus, there is a need for an approach that reduces the scale risk to a minimum and allows for an increase the increase in production.

The present invention addresses these and other problems with a desalination system having a seawater feed line and a brine reject line, with hybrid treatment using a selective adsorbent for divalent ion and electrodialysis for the production of water, calcium and magnesium salts with high recovery (i.e., a high produced freshwater-to-feed water ratio). The desalination plant feed is treated in two steps to remove the sparingly soluble salts from the feed, using zeolite as a filter to remove calcium scale and an electrodialysis selective membrane to remove magnesium. This approach to treatment significantly reduces the scale risk and allows the production of a larger amount of fresh water from the same amount of raw seawater. Further, the reject stream has high salt content which may be directed to zero liquid discharge technology or otherwise utilized, for example as a concentrated mineral source. and other product streams, such as high concentration saline water for feeding to a zero liquid discharge unit.

In the present invention, treatment for the removal of divalent ions may be installed after the first stage of desalination, an arrangement which can reduce the installation cost and minimize the cost of produced water. Seawater optionally first passes through a standard desalination unit (thermal or membrane), and the concentrated salt water is treated in a physicochemical adsorption process (such as passage through a calcium-selective adsorbent) and then directed to magnesium selective electrodialysis.

The calcium adsorbent material is intended to remove the majority of the calcium content, which may then be extracted by product water backwash. Electrodialysis produce two main streams, including a magnesium-enriched brine and a residue enhanced in monovalent salts. Magnesium is commercially attractive and may be extracted for further use. Importantly, the remaining brine stream would be free of scaling salts, which allows this stream to be further treated by a second stage desalination unit with greatly minimized scaling risk. The lower scaling risk substantially reduces or eliminates the prior art's limitations on the efficiency of the water production process due to scaling, thereby allowing more fresh water to be produced from the source water. The present invention thus may increase process efficiency in a system with integrated calcium and magnesium production, and may generate an enriched monovalent brine suitable for, for example, use in salt ponds for heat storage or as a commercially attractive source of sodium and potassium chloride.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a system for the integrated production of water and salts outputs in accordance with an embodiment of the present invention.

FIG. 2 is a schematic illustration of a system for the integrated production of water and salts outputs in accordance with another embodiment of the present invention.

FIG. 3 is a flowchart of a method in accordance with an embodiment of the present invention.

### DETAILED DESCRIPTION

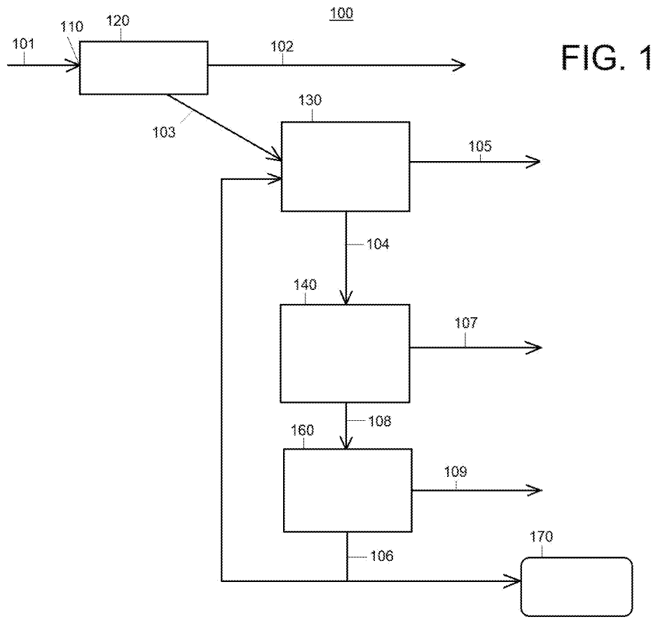

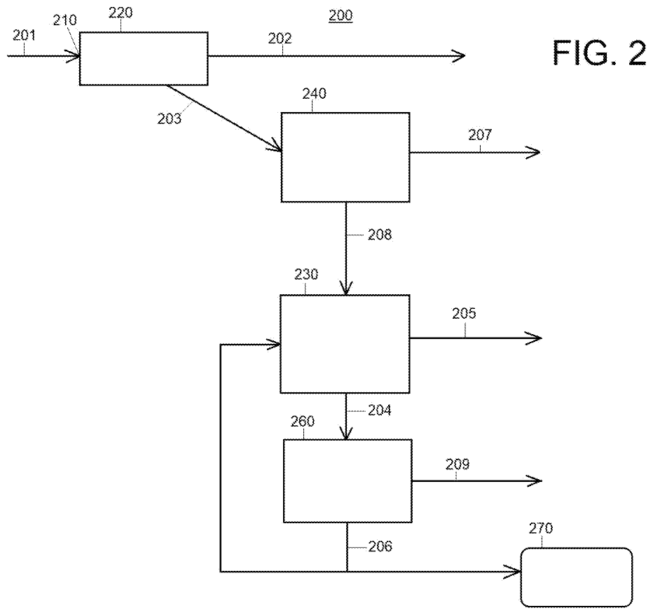

FIGS. 1 and 2 are schematic illustrations of the systems in accordance with the present invention with variations in arrangements that reduce the scale risk, produce concentrated calcium and magnesium products, and increase the ratio of product water production relative to the amount of feed water input.

In the following descriptions, calculations of mass and heat balances in the FIG. 1 and FIG. 2 embodiments are provided, using a 1000 ton seawater feed flow for example purposes.

In the system 100 shown in FIG. 1, feed seawater 101 is received at the system intake 110. In this example the feed seawater has a total dissolved solids (TDS) concentration of 42,481 parts per million (ppm), as shown in the first column of Table 1, below. Table 1 is a water quality table showing representative expected concentrations of components in a salt plant feed and the corresponding streams calculated for this embodiment of the present invention. At the system intake 110, the feed seawater TDS includes chloride (Cl) at 23,750 ppm, sodium (Na) at 12,750 ppm, sulfate (SO₄) at 3,467 ppm, magnesium (Mg) at 1,476 ppm, potassium (K) at 470 ppm, calcium (Ca) at 415 ppm, and bicarbonate (HCO₃) at 153 ppm.

The feed seawater 101 is fed into a reverse osmosis (RO) treatment unit 120. The present invention is not limited to an RO pretreatment process, but may be performed in an MSF, MED, or another desalination process. The output process streams include an RO product water stream 102 and an RO reject (brine) stream 103.

In this example the RO treatment product water yield is 40% (i.e., 400 tons), with a TDS of 250 ppm in the product stream 102. The RO reject stream 103, at 600 tons, has higher concentrations of dissolved solids. As shown in the second column of Table 1, the TDS has increased to 70,802 TDS, with corresponding increases in the constituents: 39,583 ppm Cl, 21,250 ppm Na, 5778 ppm SO₄, 2,460 ppm Mg, 783 ppm K, 692 ppm Ca and 255 ppm HCO₃.

The brine obtained from the first treatment stage 120 is passed through a calcium adsorbent unit 130 designed is intended to remove the majority of the calcium content from the reject stream 103. The output from the calcium adsorbent unit 130 includes the 600 tons of reduced-calcium-content brine stream 104 and a concentrated calcium product stream 105. The calcium product stream 105 may be generated by periodic back-flushing of the calcium adsorbent unit 130 with distillate or other water source such as reduced-concentration brine to remove the bulk of the adsorbed calcium in concentrated form.

In one embodiment of the invention, calcium adsorbent unit 130 includes pairs of packed vessels of modified porous Linde® type A zeolite material, which can selectively adsorb divalent ions. In a pre-operational phase, each vessel is conditioned by passing the following volumes of solution through at a flow rate less than 10% of the normal operational flow rate: seawater heated to 35-45° C. at 20-50 times the vessel internal volume, followed by 10-15 times the vessel internal volume of sodium chloride brine at concentration of 50-150 grams/liter. The heating may be obtained, for example, from another thermal component of the present invention's hybrid plant.

The two vessels may be used alternately, allowing the inactive vessel to be periodically back-flushed while the active vessel maintains continuous reject stream 103 flow though the calcium adsorbent unit 130. While the reject stream 103 containing 10-20 times the internal volume of the active vessel is passed through the active vessel, the inactive vessel is flushed at a flow rate of 100-1000 m³ per hour with product water from another stage of the system that needs re-mineralization and then at a flow rate of 100-1000 m³ per hour with reject from another portion of the system to elute excess divalent ions from the adsorbent material (stream 106, discussed further below). The calcium recovery process is then alternated so that the reject stream 103 is passed through the vessel from which calcium was removed, while product water and brine are passed sequentially through the other vessel of the calcium adsorbent unit 130.

The reduced-calcium-content brine stream 104 leaving the calcium adsorbent unit 130 has a slightly reduced TDS concentration of 70,179 ppm, due to the reduction in the Ca content to approximately 10% of the incoming reject stream 103 to 69 ppm. The stream 104 is introduced to a selective membrane electrodialysis unit 140, where magnesium and some of the residual calcium are selectively removed. The magnesium hydroxide isolated in this process is of significant commercial interest as a source of magnesium. The magnesium-rich product stream 107 from the electrodialysis unit 140 therefore may be further processed in a magnesium salt production unit 150.

After the preceding calcium and magnesium removal processes, the product brine output stream 108 from the electrodialysis unit 140 is approximately 540 tons (i.e., a 10% recovery from the incoming 600 tons), and is essentially free of divalent scale forming salts (Ca at 77 ppm, a slight increase in concentration relative to input stream 104's Ca concentration of 69 ppm due to 10% of water diversion to stream 107). The nearly divalent ion-free electrodialysis unit reject stream 108 may then be subjected to a further desalination stage to salt concentration levels well above those previously limited by scaling risk, to produce commercially viable brine concentration and purity product, as well as producing more fresh water. An example of this further desalination processing occurs in the FIG. 1 embodiment at a high-temperature (above 80° C.) MED unit 160. While any desalination technology could be applied at this further desalination stage, in this embodiment the use of high-temperature MED provides the benefit of a source of supply of heated water to the zeolite in calcium adsorbent unit 130 for the initial media conditioning process.

The salt concentration in the FIG. 1 embodiment is at a 1.5 concentration factor (CF), resulting in increases in the incoming electrodialysis reject stream 108 concentrations of: 78,064 to 117,096 ppm TDS, 43,981 to 65,972 Cl, 23,611 to 35,417 ppm Na, 6,420 to 9,631 SO₄, 870 to 1,306 K and 283 to 424 HCO₃ in the effluent high-temperature MED concentrated stream 106. At these concentrations, the salt concentration of the concentrated stream 106 will be on the order of 110-120 grams per liter, making this stream suitable for, for example, use in solar ponds for thermal energy storage or in a zero liquid discharge system 170. The zero liquid discharge system may utilize, for example, crystallization by at least one of a thermal process and a reverse osmosis process

In addition to the production of the high-concentration salt stream 106, the use of the downstream desalination stage 160 produces a significant amount of additional product water 109, in this embodiment 178 tons of essentially aero TDS water while reducing the volume of the high-concentration salt stream 106 to 362 tons. Thus, in this embodiment of the present invention the overall recovery of the system is substantially increased to 58%, a level not previously economically feasible with conventional scale-risk-limited desalination systems.

TABLE 1
Stream Compositions at Stages of the FIG. 1 Embodiment

| | | | Calcium | Electro- | |
|---|---|---|---|---|---|
| | Seawater | | Adsorbent | Dialysis | HT-MED |
| | Feed | RO Reject | Unit Reject | Reject | Reject |
| | (Jubail) | Stream 103 | Stream 104 | Stream 108 | Stream 106 |
| | Notes | | | | |
| | | 40% yield | | 10% yield | CF = 1.5 |
| Sulfate SO₄ | 3467 | 5778 | 5778 | 6420 | 9631 |
| Chloride Cl | 23750 | 39583 | 39583 | 43981 | 65972 |
| Bicarbonate HCO₃ | 153 | 255 | 255 | 283 | 425 |
| Calcium Ca | 415 | 692 | 69 | 77 | 115 |
| Potassium | 470 | 783 | 783 | 870 | 1306 |
| Magnesium Mg | 1476 | 2460 | 2460 | 246 | 369 |
| Sodium Na | 12750 | 21250 | 21250 | 23611 | 35417 |
| (TDS) | 42481 | 70802 | 70179 | 78064 | 117096 |

FIG. 2 shows another embodiment of the present invention in which the electrodialysis unit 240 and the calcium adsorbent unit 230 arrangements are reversed.

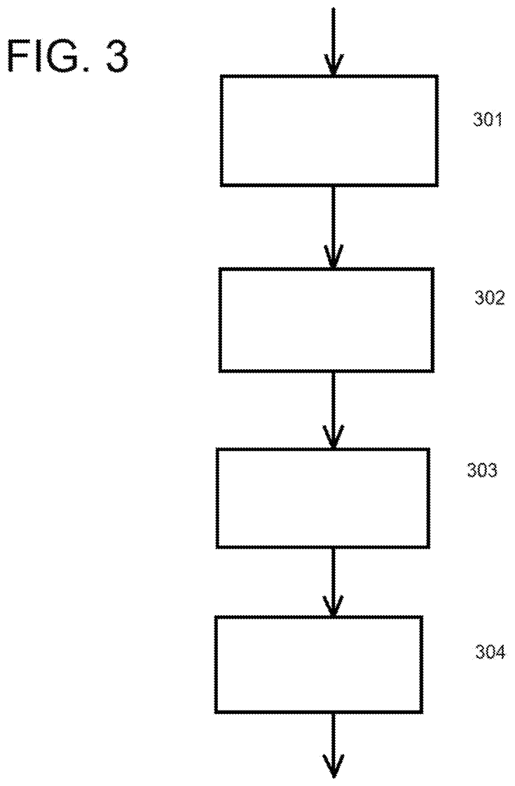

FIG. 3 shows an embodiment of a method in accordance with the present invention. In step 301, raw seawater is received into the system, preferably by a desalination unit which produces product fresh water stream and a reject stream. In step 302 the reject stream is subjected to a dual treatment process including a physicochemical adsorption unit which removes calcium from the reject stream and an electrodialysis unit which removes magnesium from the reject stream. As discussed above, the arrangements of the physicochemical adsorption unit and the electrodialysis unit may be reversed.

Following the dual treatment, the reject stream preferably enters a second desalination unit in step 303, where the reduced concentration of minerals associated with scaling permits the desalination process to be performed at higher operating parameters (such as higher temperature) to further increase the product fresh water yield from the source raw seawater. In step 304, the highly-concentrated minerals removed from the seawater, specifically the concentrated calcium and magnesium, are removed from the system (in the case of the calcium, by back-flushing of the physicochemical adsorption unit) for subsequent beneficial use.

The foregoing disclosure has been set forth merely to illustrate the invention and is not intended to be limiting. Because such modifications of the disclosed embodiments incorporating the spirit and substance of the invention may occur to persons skilled in the art, the invention should be construed to include everything within the scope of the appended claims and equivalents thereof.

### LISTING OF REFERENCE LABELS

100, 200 high recovery desalination system
101, 201 seawater feed
102, 202 RO product water stream
103, 203 RO reject stream
104, 204 reduced-calcium-content brine stream
105, 205 calcium product stream
106, 206 high-temperature MED concentrated stream
107, 207 magnesium-rich product stream
108, 208 electrodialysis unit reject stream
109, 209 downstream desalination product water
110, 210 system intake
120, 220 first treatment unit
130, 230 calcium adsorbent unit
140, 240 electrodialysis unit
150, 250 magnesium salt production unit
160, 260 downstream desalination stage
170, 270 solar pond/zero liquid discharge system

What is claimed is:

1. A desalination system, comprising:
a first desalination unit configured to receive saline water and produce a first desalinated product water stream and a reject stream from the saline water;
a calcium adsorbent unit configured to remove calcium from the first desalination reject stream;
an electrodialysis unit configured to remove magnesium from the first desalination reject stream; and
a second desalination unit configured to receive the first desalination reject stream after removal of calcium by the calcium adsorbent unit and magnesium by the electrodialysis unit and produce a second desalinated product water stream and a second desalination unit reject stream.

2. The desalination system of claim 1, wherein
the second desalination unit is operated with a concentration factor of 1.5.

3. The desalination system of claim 2, wherein
the calcium adsorbent unit includes calcium-capturing zeolite material.

4. The desalination system of claim 3, wherein
the calcium-capturing zeolite material is contained in at least two vessels, and
the at least two vessels are isolatable from one another in a manner that permits calcium recovery back-flushing in at least one of the at least two vessels while the first desalination reject stream continues to be received by another one of the at least two vessels.

5. The desalination system of claim 4, wherein
the calcium absorbent unit receives the first desalination reject stream from the first desalination unit and outputs the first desalination reject stream with reduced calcium concentration to the electrodialysis unit, and
the electrodialysis unit outputs the first desalination reject stream with the reduced calcium concentration and the reduced magnesium concentration to the second desalination unit.

6. The desalination system of claim 4, wherein
the electrodialysis unit receives the first desalination reject stream from the first desalination unit and outputs the first desalination reject stream with reduced magnesium concentration to the calcium absorbent unit, and
the calcium adsorbent unit outputs the first desalination reject stream with the reduced calcium concentration and the reduced magnesium concentration to the second desalination unit.

7. The desalination system of claim 5, wherein at least a portion of a second desalination unit reject stream is recycled to the calcium adsorbent unit.

8. The desalination system of claim 5, wherein at least a portion of a second desalination unit reject stream is recycled to the calcium adsorbent unit.

9. The desalination system of claim 1, wherein
at least a portion of the second desalination unit reject stream is output to at least one of a solar pond and a desalination plant zero liquid discharge system.

10. The desalination system of claim 9, wherein
the zero liquid discharge system includes crystallization by at least one of a thermal and a reverse osmosis process.

11. The desalination system of claim 1, wherein
the calcium adsorbent unit and the electrodialysis unit cooperate to remove from the first desalination reject stream at least 90% of calcium and magnesium in the saline water.

12. A method of operating a desalination unit, comprising the acts of:
selectively filtering water using a dual treatment system to remove calcium and magnesium from the water, the dual treatment system including a physicochemical adsorption unit configured to remove calcium and an electrodialysis unit configured to remove magnesium;
directing a reject stream from the dual treatment system to a downstream desalination unit; and
producing using the downstream desalination unit a product water stream and a concentrated salt reject stream.

13. The method of claim 12, further comprising the act of:
before the selective filtering act, desalinating saline water to produce the water to be selectively filtered using the dual treatment system.

14. The method of claim 13, wherein
in the dual treatment system, the physicochemical adsorption unit is upstream of the electrodialysis unit.

15. The method of claim 13, wherein
in the dual treatment system, the electrodialysis unit physicochemical adsorption unit is upstream of the physicochemical adsorption unit.

16. The method of claim 13, further comprising the act of:
directing at least a portion of a second desalination unit reject stream to at least one of a solar pond and a desalination plant zero liquid discharge system.

17. The method of claim 12, wherein
the dual treatment system removes at least 90% of the calcium and the magnesium in the saline water.

18. The method of claim 13, further comprising the acts of:
directing at least a portion of a second desalination unit reject stream to a desalination plant zero liquid discharge system; and
performing crystallization in the desalination plant zero liquid discharge system by a thermal process or a reverse osmosis process.

19. The method of claim 12, wherein
the physicochemical adsorption unit includes at least two vessels containing a calcium-capturing zeolite material, and
the at least two vessels are isolatable from one another in a manner that permits calcium recovery back-flushing in at least one of the at least two vessels while the first desalination reject stream continues to be received by another one of the at least two vessels.

20. The method of claim 19, further comprising the act of:
recovering calcium from at least one of the vessels by back-flushing.
